(19) United States
(12) Patent Application Publication
(10) Pub. No.: US 2024/0166511 A1
(43) Pub. Date: May 23, 2024

(54) PROCESSES AND APPARATUSES FOR SEPARATING HYDROGEN FROM HYDROCARBONS

(71) Applicant: UOP LLC, Des Plaines, IL (US)

(72) Inventors: Shubhra J. Bhadra, Naperville, IL (US); Kathryn R. Bjorkman Marrou, Mount Prospect, IL (US)

(21) Appl. No.: 18/056,747

(22) Filed: Nov. 18, 2022

(51) Int. Cl. C01B 3/56; B01D 53/04

(52) U.S. Cl. CPC C01B 3/56; B01D 53/0462; B01D 2253/102; B01D 2253/104; B01D 2253/106; B01D 2253/108; B01D 2253/204; B01D 2256/16; B01D 2257/702; B01D 2259/40054; B01D 2259/402; B01D 2259/4065; C01B 2210/0021; C01B 2210/007

(57) ABSTRACT

Processes and apparatuses for providing a high purity hydrogen stream by removing hydrocarbons with a thermal swing adsorption process. An adsorbent is used to remove the hydrocarbons and provide a product stream that is an enriched hydrogen stream. A portion of the product stream is heated and used as a purge stream to desorb the hydrocarbons from the adsorbent. A contaminated stream including hydrogen and the hydrocarbons is cooled and separated in a gaseous stream and a liquid steam. The vapor stream is mixed with the feed stream. A blower may be used with the vapor stream.

### FIELD OF THE INVENTION

This invention relates generally to processes and apparatuses for separating hydrogen from hydrocarbons, and more particularly to processes and apparatuses which use a heat portion of the hydrogen product stream as a purge stream.

### BACKGROUND OF THE INVENTION

Hydrogen from solar, wind, and water (Green Hydrogen) could meet projected global energy demand in the future and can play a vital role in reducing global warming. The recently renewed interest in alternative energy sources and energy carriers opens up new prospects for this process to be applied as a feed system for fuel cells, power generation and many more applications.

The reversible dehydrogenation reaction of methylcyclohexane (MCH) to produce toluene (TOL) and hydrogen (through so called MTH cycle) was proposed as a solution for the storage, transportation, and distribution of hydrogen produced from renewable energy sources. For power generation, the hydrogen from this process is usually compressed for the downstream power generation unit. Usually, the purity requirement for power generation unit is very tight (BTX<1 ppm). Due to the relatively high cost associated with the green hydrogen production, it is necessary to recover almost all hydrogen.

Pressure swing adsorption (PSA) can be a viable option for separation of hydrogen using conventional adsorbents such as activated alumina, silica gel, carbon, zeolite, etc. However, void loss from the PSA process is usually high and in order to minimize the loss, a recycle scheme is required. Typically, more than 95% of tail gas is required to be recycled back to the PSA feed to maintain 98+% recovery. This recycle makes the overall economics of purifying hydrogen from such processes unattractive.

Accordingly, it would be desirable to have more effective and efficient ways to purify hydrogen and in particular hydrogen produced from a renewable resource.

### SUMMARY OF THE INVENTION

One or more processes and apparatuses for purifying a hydrogen stream with a temperature swing adsorption (TSA) process has been invented. The utilization of the TSA for providing the high purity hydrogen stream has a significant potential in maintaining high recovery (98+%) without requiring any compression in a compressor. The TSA utilized in the present invention is a close loop regeneration scheme which uses a portion of the high purity and high-pressure hydrogen product stream as the purge stream. This reduces the hydrogen loss and ensures a high purity product.

Therefore, the present invention may be characterized, in at least one aspect, as providing a process for separating hydrogen from hydrocarbons by: passing a feed stream comprising hydrogen and hydrocarbons to an adsorption zone; separating the hydrogen from the hydrocarbons in the adsorption zone by selectively adsorbing the hydrocarbons to provide an enriched hydrogen product stream; heating a portion of the enriched hydrogen product stream as a purge stream; desorbing the hydrocarbons with the purge stream and to provide a contaminated stream; and, separating the contaminated stream into a hydrogen stream and a hydrocarbon stream in a separation zone.

The adsorbing and desorbing may be both done at a pressure that is substantially the same.

The process may further include combining the hydrogen stream with the feed stream. The separation zone may include a cooler and a separation vessel. The separation vessel may be configured to provide a liquid hydrocarbon stream. A blower may be used to combine the hydrogen stream with the feed stream.

The adsorption zone may include one or more packed beds containing an adsorbent selected from a group consisting of silica gel, alumina, zeolite, activated carbon, MOF, or a combination thereof.

The adsorption zone may include a plurality of vessels each containing packed beds with the adsorbent. While a first vessel is separating the hydrogen from the hydrocarbons in the adsorption zone by selectively adsorbing the hydrocarbons to provide an enriched hydrogen product stream, a second vessel may be passing the purge stream to the adsorption zone and desorbing the hydrocarbons and provide a contaminated stream.

In a second aspect, the present invention may be generally characterized as proving a temperature swing adsorption process for recovering hydrogen from a stream comprising hydrogen and hydrocarbons by: adsorbing, at a predetermined pressure and temperature, hydrocarbons from a feed stream containing hydrogen and hydrocarbons with an adsorbent and producing a product stream enriched in hydrogen; heating a portion of the product stream as a purge stream; desorbing the hydrocarbons from the adsorbent with the purge stream and producing a contaminated stream comprising hydrogen and hydrocarbons at a pressure substantially the same as the predetermined pressure of the adsorbing step; and, separating the contaminated stream into a liquid stream comprising hydrocarbons and a vapor stream comprising hydrogen.

The process may further include combining the vapor stream with the feed stream. A blower may be utilized for the combining step.

The adsorbent may be selected from a group consisting of silica gel, alumina, zeolite, activated carbon, MOF, or a combination thereof.

The process may include cooling the contaminant stream before the separating step.

The adsorbing step may be carried out in a first vessel simultaneously while the desorbing step is carried out in a second vessel.

In a third aspect, the present invention may broadly be characterized as providing an apparatus for separating hydrogen from hydrocarbons, the apparatus including: an adsorption zone with a first vessel configured to receive a feed stream comprising hydrogen and hydrocarbons, the first vessel with an adsorbent configured to selectively adsorb the hydrocarbons, and the first vessel configured to provide an enriched hydrogen product stream; a heater configured to receive a portion of the enriched hydrogen product stream and provide a purge stream; a line configured to transfer the purge stream from the heater to the first vessel to desorb the hydrocarbons with the purge stream and provide a contaminated stream; and, a separation zone having a vessel configured to separate the contaminated stream into a hydrogen stream and a hydrocarbon stream.

The apparatus may further include a line configured to combine the hydrogen stream with the feed stream. A blower may be provided in the line configured to combine the hydrogen stream with the feed stream.

The adsorbent may be selected from a group consisting of silica gel, alumina, zeolite, activated carbon, MOF, or a combination thereof.

The separation zone may further include a cooler configured to cool the contaminated stream.

The adsorption zone may further include a second vessel configured to receive the feed stream comprising hydrogen and hydrocarbons, the second vessel having an adsorbent configured to selectively adsorb the hydrocarbons and provide an enriched hydrogen stream.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

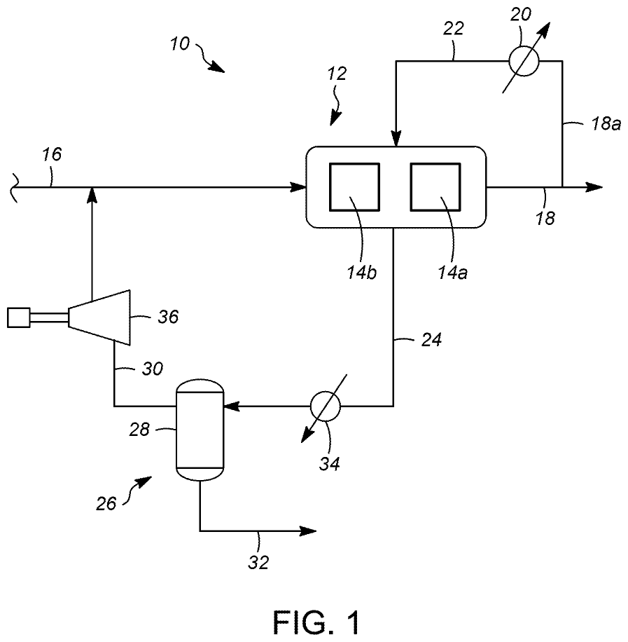

FIG. 1 is a process flow diagram according to the present invention; and,

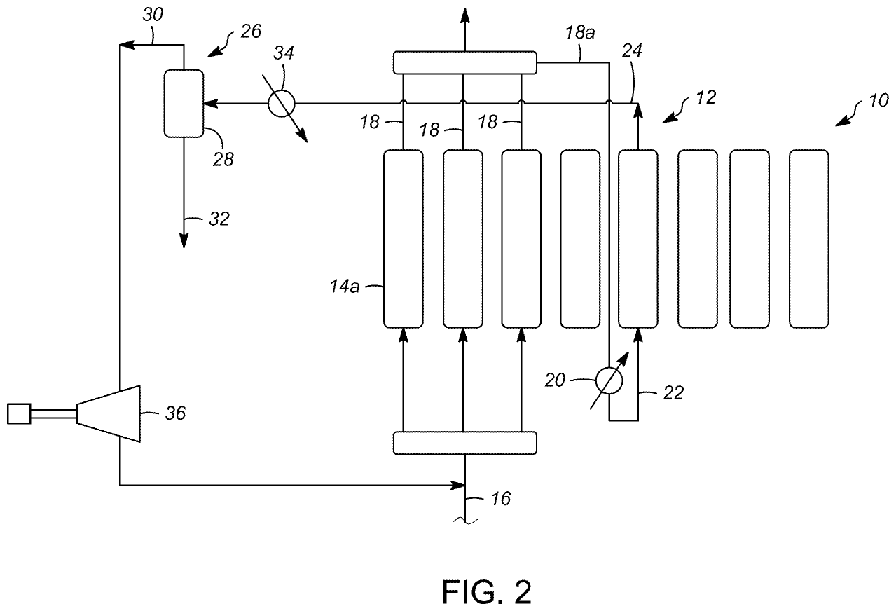

FIG. 2 is another process flow diagram according to the present invention.

### DETAILED DESCRIPTION OF THE INVENTION

As mentioned above, the present invention utilizes a TSA process to purify a hydrogen stream. The TSA processes rely on the fact that at cold temperatures gases tend to be adsorbed within the pore structure of the microporous adsorbent materials or within the free volume of a polymeric material. When the temperature of the adsorbent is increased, the adsorbed gas is released, or desorbed. By cyclically swinging the temperature of adsorbent beds between low temperatures to adsorb and higher temperatures to desorb, the TSA processes can be used to separate gases in a mixture when used with an adsorbent that is selective for one or more of the components in a gas mixture that are to be removed.

In other words, the present invention involves a TSA process for recovering hydrogen containing hydrocarbons by adsorbing hydrocarbons through passing a feed stream containing hydrogen at a concentration of more than 98 mole percent to a packed bed containing adsorbent such as silica gel, alumina, zeolite, activated carbon, MOF, or combinations thereof at a predetermined pressure and temperature, and producing a product stream enriched in hydrogen. A fraction of product stream is heated as purge stream and said hot purge stream is passed through said adsorption bed to remove impurities and produce a contaminated stream at the same pressure, or substantially the same, of the adsorption step. The contaminated stream is passed to a separator to reject hydrocarbons as liquid stream and produce a vapor stream comprising hydrogen similar or lower than said feed stream. The vapor stream and the feed stream may be mixed with the help of a blower.

With these general principles in mind, one or more embodiments of the present invention will be described with the understanding that the following description is not intended to be limiting.

As shown in FIGS. 1 and 2, an apparatus 10 for separating hydrogen from hydrocarbons includes an adsorption zone 12 having one or more adsorption vessels, or beds, 14a, 14b. Generally, more than one adsorption vessel 14a, 14b are utilized in order for at least one adsorption bed to be producing product while another bed is regenerating. In this way, product gas can be produced on a continuous basis.

An exemplary cycle used for TSA is shown in greater detail in FIG. 2 which depicts a time series of steps for a single bed, for example adsorption vessel 14a experienced over the course of a single cycle. While only adsorption vessel 14a is depicted, more than one TSA beds may be in the adsorption, or feed, step simultaneously.

In the example shown in FIG. 2, the TSA process uses two beds, where the first bed undergoes each step of the TSA cycle in sequence and the second bed also undergoes each step of the TSA cycle in the same sequence order, however the timing of the two beds is arranged such that the start and finish of the two beds are staggered. The cycle schedule is also shown in tabular format in TABLE 1, below.

TABLE 1

| | | | | | | | | |
|---|---|---|---|---|---|---|---|---|
| BED 1 | F1 | F2 | F3 | IDLE | HEAT | COOL | RP | IDLE |

| | | | | | | | | |
|---|---|---|---|---|---|---|---|---|
| BED 2 | IDLE | HEAT | COOL | RP | IDLE | F1 | F2 | F3 |

In the schedule, each row of the grid represents all the different cycle steps a given bed undergoes over the entire cycle, whereas a column of the grid represents which cycle step is being run by which bed at a particular unit time step. The total cycle time is the sum of all the individual unit time steps of a particular row. The cycle comprises a feed or adsorption step (divided into steps F1, F2, and F3 to demonstrate how the feed or adsorption step matches with the other steps), a heating step (HEAT), a cooling step (COOL), a re-pressurization step (RP) and an idle step (IDLE).

Once an adsorption bed has been pressurized to the highest-pressure level of the cycle with product hydrogen stream and the temperature of interest in the bed is constant (typically within 5 degrees C. of design), the cooled feed stream is introduced to the inlet end of bed and the un-adsorbed pure hydrogen stream comprising hydrogen is discharged from the outlet end of bed. The feed or adsorption step is continued until the mass transfer zone (MTZ) of preferentially adsorbed component reaches the exit end of the bed without substantially breaking through it.

At the termination of the feed step, the bed is heated with product hydrogen stream. During the heat-up step, the effluent comprising the one or more impurities is withdrawn. Following the heat-up step, the bed is cooled down and re-pressurized using product hydrogen stream to the feed pressure level for initiation and repetition of the cycle.

The adsorption vessels 14a, 14b may contain a single adsorbent or multiple adsorbents to selectively adsorb the hydrocarbons. Suitable adsorbent or adsorbents may be selected by those skilled in the art. The absorbent may include silica gel, alumina, zeolite, activated carbon, MOF, or a combination thereof. The adsorption vessels 14a, 14b, are configured to receive a feed stream 16 comprising hydrogen and hydrocarbons and to provide an enriched hydrogen product stream 18 having a greater concentration of hydrogen compared to the feed stream 16.

A heater 20 is provided to receive and heat a portion 18a of the enriched hydrogen product stream 18 to provide a hot purge stream 22. The purge stream 22 is transferred in line from the heater 20 to the one of the adsorption vessels 14a, 14b. In FIG. 2, adsorption vessel 14a is depicted as receiving the purge stream 22. As would be appreciated, this is merely exemplary as the adsorption vessels 14a, 14b, cycle through the various stages of the TSA process. An exemplary TSA process is described in U.S. Pat. No. 11,097,219.

The purge stream 22 heats the adsorbent which results in the desorbing of the hydrocarbons from the adsorbent. A contaminated stream 24 containing the desorbed hydrocarbons and hydrogen is provided by the adsorption vessels 14a, 14b which receives the purge stream 22.

The apparatus 10 also includes a separation zone 26 having a separation vessel 28 configured to allow the contaminated stream 24 to separate into a gaseous stream 30, including mostly hydrogen, and a liquid stream 32, including the desorbed hydrocarbons. A cooler 34 may be provided to cool the contaminated stream 24 to facilitate separation of the hydrogen and hydrocarbons. The gaseous stream 30 is combined with the feed stream 16. A blower 36 may be utilized in the line which combines the gaseous stream 30 with the feed stream 16.

As is known the adsorption zone 12 typically includes a plurality of adsorption vessels 14a, 14b, some of which are adsorbing hydrocarbons to provide the product stream 18, some of which are receiving the purge stream 22 and which are desorbing hydrocarbons. The adsorbing and desorbing steps are both done at a pressure that is substantially the same. By “substantially the same” it is meant that the pressures are within 10%, or 5%, or 2% of each other.

### Experiments

In a simulated process, separation of hydrocarbons from a feed stream comprising 98.97% hydrogen and trace C1 to C6 hydrocarbons was analyzed with a TSA and a blower according to the present invention and it indicated that recovery of 99.9% hydrogen was possible. While simulation of a separation with a PSA with a compressor showed only slightly lower recovery (99.5%), the PSA required a larger bed volume (270 m³ compared with 78 m³) and also required significantly more power (825 KW v. 250 KW). Thus, the present invention provides a more efficient and effective way to obtain a high purity hydrogen stream. Thus, the present invention allows the TSA separation process to be utilized while minimizing hydrogen loss.

It should be appreciated and understood by those of ordinary skill in the art that various other components such as valves, pumps, filters, coolers, etc. were not shown in the drawings as it is believed that the specifics of same are well within the knowledge of those of ordinary skill in the art and a description of same is not necessary for practicing or understanding the embodiments of the present invention.

Any of the above lines, conduits, units, devices, vessels, surrounding environments, zones or similar may be equipped with one or more monitoring components including sensors, measurement devices, data capture devices or data transmission devices. Signals, process or status measurements, and data from monitoring components may be used to monitor conditions in, around, and on process equipment. Signals, measurements, and/or data generated or recorded by monitoring components may be collected, processed, and/or transmitted through one or more networks or connections that may be private or public, general, or specific, direct or indirect, wired or wireless, encrypted or not encrypted, and/or combination(s) thereof; the specification is not intended to be limiting in this respect.

Signals, measurements, and/or data generated or recorded by monitoring components may be transmitted to one or more computing devices or systems. Computing devices or systems may include at least one processor and memory storing computer-readable instructions that, when executed by the at least one processor, cause the one or more computing devices to perform a process that may include one or more steps. For example, the one or more computing devices may be configured to receive, from one or more monitoring component, data related to at least one piece of equipment associated with the process. The one or more computing devices or systems may be configured to analyze the data. Based on analyzing the data, the one or more computing devices or systems may be configured to determine one or more recommended adjustments to one or more parameters of one or more processes described herein. The one or more computing devices or systems may be configured to transmit encrypted or unencrypted data that includes the one or more recommended adjustments to the one or more parameters of the one or more processes described herein.

### SPECIFIC EMBODIMENTS

While the following is described in conjunction with specific embodiments, it will be understood that this description is intended to illustrate and not limit the scope of the preceding description and the appended claims.

A first embodiment of the invention is a process for separating hydrogen from hydrocarbons, the process comprising passing a feed stream comprising hydrogen and hydrocarbons to an adsorption zone; separating the hydrogen from the hydrocarbons in the adsorption zone by selectively adsorbing the hydrocarbons to provide an enriched hydrogen product stream; heating a portion of the enriched hydrogen product stream as a purge stream; desorbing the hydrocarbons with the purge stream and to provide a contaminated stream; and, separating the contaminated stream into a hydrogen stream and a hydrocarbon stream in a separation zone. An embodiment of the invention is one, any or all of prior embodiments in this paragraph up through the first embodiment in this paragraph, wherein the adsorbing and desorbing are both done at a pressure that is substantially the same. An embodiment of the invention is one, any or all of prior embodiments in this paragraph up through the first embodiment in this paragraph, further comprising combining the hydrogen stream with the feed stream. An embodiment of the invention is one, any or all of prior embodiments in this paragraph up through the first embodiment in this paragraph, wherein the separation zone comprises a cooler and a separation vessel, the separation vessel configured to provide a liquid hydrocarbon stream. An embodiment of the invention is one, any or all of prior embodiments in this paragraph up through the first embodiment in this paragraph, wherein a blower is used to combine the hydrogen stream with the feed stream. An embodiment of the invention is one, any or all of prior embodiments in this paragraph up through the first embodiment in this paragraph, wherein the adsorption zone comprises one or more packed beds containing an adsorbent selected from a group consisting of silica gel, alumina, zeolite, activated carbon, MOF, or a combination thereof. An embodiment of the invention is one, any or all of prior embodiments in this paragraph up through the first embodiment in this paragraph, wherein the adsorption zone comprises a plurality of vessels each containing packed beds with the adsorbent. An embodiment of the invention is one, any or all of prior embodiments in this paragraph up through the first embodiment in this paragraph, wherein while a first vessel is separating the hydrogen from the hydrocarbons in the adsorption zone by selectively adsorbing the hydrocarbons to provide an enriched hydrogen product stream, a second vessel is passing the purge stream to the adsorption zone and desorbing the hydrocarbons and provide a contaminated stream.

A temperature swing adsorption process for recovering hydrogen from a stream comprising hydrogen and hydrocarbons, the process comprising the steps of adsorbing, at a predetermined pressure and temperature, hydrocarbons from a feed stream containing hydrogen and hydrocarbons with an adsorbent and producing a product stream enriched in hydrogen; heating a portion of the product stream as a purge stream; desorbing the hydrogens from the adsorbent with the purge stream and producing a contaminated stream comprising hydrogen and hydrocarbons at a pressure substantially the same as the predetermined pressure of the adsorbing step; and, separating the contaminated stream into a liquid stream comprising hydrocarbons and a vapor stream comprising hydrogen. An embodiment of the invention is one, any or all of prior embodiments in this paragraph up through the first embodiment in this paragraph, further comprising the step of combining the vapor stream with the feed stream. An embodiment of the invention is one, any or all of prior embodiments in this paragraph up through the first embodiment in this paragraph, wherein a blower is utilized for the combining step. An embodiment of the invention is one, any or all of prior embodiments in this paragraph up through the first embodiment in this paragraph, wherein the adsorbent is selected from a group consisting of silica gel, alumina, zeolite, activated carbon, MOF, or a combination thereof. An embodiment of the invention is one, any or all of prior embodiments in this paragraph up through the first embodiment in this paragraph, further comprising the step of cooling the contaminant stream before the separating step. An embodiment of the invention is one, any or all of prior embodiments in this paragraph up through the first embodiment in this paragraph, wherein the adsorbing step is carried out in a first vessel simultaneously while the desorbing step is carried out in a second vessel.

A second embodiment of the invention is a temperature swing adsorption process for recovering hydrogen from a stream comprising hydrogen and hydrocarbons, the process comprising the steps of adsorbing, at a predetermined pressure and temperature, hydrocarbons from a feed stream containing hydrogen and hydrocarbons with an adsorbent and producing a product stream enriched in hydrogen; heating a portion of the product stream as a purge stream; desorbing the hydrocarbons from the adsorbent with the purge stream and producing a contaminated stream comprising hydrogen and hydrocarbons at a pressure substantially the same as the predetermined pressure of the adsorbing step; and, separating the contaminated stream into a liquid stream comprising hydrocarbons and a vapor stream comprising hydrogen. An embodiment of the invention is one, any or all of prior embodiments in this paragraph up through the second embodiment in this paragraph, further comprising the step of combining the vapor stream with the feed stream. An embodiment of the invention is one, any or all of prior embodiments in this paragraph up through the second embodiment in this paragraph, wherein a blower is utilized for the combining step. An embodiment of the invention is one, any or all of prior embodiments in this paragraph up through the second embodiment in this paragraph, wherein the adsorbent is selected from a group consisting of silica gel, alumina, zeolite, activated carbon, MOF, or a combination thereof. An embodiment of the invention is one, any or all of prior embodiments in this paragraph up through the second embodiment in this paragraph, further comprising the step of cooling the contaminant stream before the separating step. An embodiment of the invention is one, any or all of prior embodiments in this paragraph up through the second embodiment in this paragraph, wherein the adsorbing step is carried out in a first vessel simultaneously while the desorbing step is carried out in a second vessel.

A third embodiment of the invention is an apparatus for separating hydrogen from hydrocarbons, the apparatus comprising an adsorption zone comprising a first vessel configured to receive a feed stream comprising hydrogen and hydrocarbons, the first vessel comprising an adsorbent configured to selectively adsorb the hydrocarbons, and the first vessel configured to provide an enriched hydrogen product stream; a heater configured to receive a portion of the enriched hydrogen product stream and provide a purge stream; a line configured to transfer the purge stream from the heater to the first vessel to desorb the hydrocarbons with the purge stream and provide a contaminated stream; and, separation zone having a vessel configured to separate the contaminated stream into a hydrogen stream and a hydrocarbon stream. An embodiment of the invention is one, any or all of prior embodiments in this paragraph up through the third embodiment in this paragraph, further comprising a line configured to combine the hydrogen stream with the feed stream. An embodiment of the invention is one, any or all of prior embodiments in this paragraph up through the third embodiment in this paragraph, further comprising a blower in the line configured to combine the hydrogen stream with the feed stream. An embodiment of the invention is one, any or all of prior embodiments in this paragraph up through the third embodiment in this paragraph, wherein the adsorbent is selected from a group consisting of silica gel, alumina, zeolite, activated carbon, MOF, or a combination thereof. An embodiment of the invention is one, any or all of prior embodiments in this paragraph up through the third embodiment in this paragraph, wherein the separation zone further comprises a cooler configured to cool the contaminated stream. An embodiment of the invention is one, any or all of prior embodiments in this paragraph up through the third embodiment in this paragraph, wherein the adsorption zone further comprises a second vessel configured to receive the feed stream comprising hydrogen and hydrocarbons, the second vessel comprising an adsorbent configured to selectively adsorb the hydrocarbons and provide an enriched hydrogen stream. Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A process for separating hydrogen from hydrocarbons, the process comprising:
passing a feed stream comprising hydrogen and hydrocarbons to an adsorption zone;
separating the hydrogen from the hydrocarbons in the adsorption zone by selectively adsorbing the hydrocarbons to provide an enriched hydrogen product stream;
heating a portion of the enriched hydrogen product stream as a purge stream;
desorbing the hydrocarbons with the purge stream and to provide a contaminated stream; and,
separating the contaminated stream into a hydrogen stream and a hydrocarbon stream in a separation zone.

2. The process of claim 1, wherein the adsorbing and desorbing are both done at a pressure that is substantially the same.

3. The process of claim 1, further comprising:
combining the hydrogen stream with the feed stream.

4. The process of claim 3, wherein the separation zone comprises:
a cooler and a separation vessel, the separation vessel configured to provide a liquid hydrocarbon stream.

5. The process of claim 3, wherein a blower is used to combine the hydrogen stream with the feed stream.

6. The process of claim 1, wherein the adsorption zone comprises one or more packed beds containing an adsorbent selected from a group consisting of silica gel, alumina, zeolite, activated carbon, MOF, or a combination thereof.

7. The process of claim 6, wherein the adsorption zone comprises a plurality of vessels each containing packed beds with the adsorbent.

8. The process of claim 7, wherein while a first vessel is separating the hydrogen from the hydrocarbons in the adsorption zone by selectively adsorbing the hydrocarbons to provide an enriched hydrogen product stream, a second vessel is passing the purge stream to the adsorption zone and desorbing the hydrocarbons and provide a contaminated stream.

9. A temperature swing adsorption process for recovering hydrogen from a stream comprising hydrogen and hydrocarbons, the process comprising the steps of:
adsorbing, at a predetermined pressure and temperature, hydrocarbons from a feed stream containing hydrogen and hydrocarbons with an adsorbent and producing a product stream enriched in hydrogen;
heating a portion of the product stream as a purge stream;
desorbing the hydrogens from the adsorbent with the purge stream and producing a contaminated stream comprising hydrogen and hydrocarbons at a pressure substantially the same as the predetermined pressure of the adsorbing step; and,
separating the contaminated stream into a liquid stream comprising hydrocarbons and a vapor stream comprising hydrogen.

10. The process of claim 9, further comprising the step of:
combining the vapor stream with the feed stream.

11. The process of claim 10, wherein a blower is utilized for the combining step.

12. The process of claim 10, wherein the adsorbent is selected from a group consisting of silica gel, alumina, zeolite, activated carbon, MOF, or a combination thereof.

13. The process of claim 10, further comprising the step of:
cooling the contaminant stream before the separating step.

14. The process of claim 10, wherein the adsorbing step is carried out in a first vessel simultaneously while the desorbing step is carried out in a second vessel.

15. An apparatus for separating hydrogen from hydrocarbons, the apparatus comprising:
an adsorption zone comprising a first vessel configured to receive a feed stream comprising hydrogen and hydrocarbons, the first vessel comprising an adsorbent configured to selectively adsorb the hydrocarbons, and the first vessel configured to provide an enriched hydrogen product stream;
a heater configured to receive a portion of the enriched hydrogen product stream and provide a purge stream;
a line configured to transfer the purge stream from the heater to the first vessel to desorb the hydrocarbons with the purge stream and provide a contaminated stream; and,
separation zone having a vessel configured to separate the contaminated stream into a hydrogen stream and a hydrocarbon stream.

16. The apparatus of claim 15, further comprising a line configured to combine the hydrogen stream with the feed stream.

17. The apparatus of claim 16, further comprising a blower in the line configured to combine the hydrogen stream with the feed stream.

18. The apparatus of claim 15, wherein the adsorbent is selected from a group consisting of silica gel, alumina, zeolite, activated carbon, MOF, or a combination thereof.

19. The apparatus of claim 15, wherein the separation zone further comprises a cooler configured to cool the contaminated stream.

20. The apparatus of claim 15, wherein the adsorption zone further comprises a second vessel configured to receive the feed stream comprising hydrogen and hydrocarbons, the second vessel comprising an adsorbent configured to selectively adsorb the hydrocarbons and provide an enriched hydrogen stream.
